(19) United States
(12) Patent Application Publication
(10) Pub. No.: US 2011/0263159 A1
(43) Pub. Date: Oct. 27, 2011

(54) ELECTRICAL CONNECTOR

(76) Inventor: Wan-Tien CHEN, Taipei (TW)

(21) Appl. No.: 12/768,027

(22) Filed: Apr. 27, 2010

(51) Int. Cl. H01R 24/00

(52) U.S. Cl. 439/630

(57) ABSTRACT

The present invention relates to an electrical connector, comprises: an insulation housing of which two sides are respectively installed with an arm portion, the inner side of each arm portion is provided with a slot hole, the outer side thereof has a latching block; and a buckling sheet having a first sheet member and a second sheet member, the right side of the first sheet member has a latching hole, and one side of the second sheet member is installed with a wing sheet, when the wing sheet is inserted in the slot hole, the latching block is latched in the latching hole, and a slit is defined at the top or bottom end of the latching block and the latching hole, such that the fastening sheet is able to be firmly welded on a substrate through adjusting the longitudinal location of the latching block inside the latching hole.

### BACKGROUND OF THE INVENTION

1. Field of the Invention

The present invention relates to an electrical connector, especially to an electrical connector in which a fastening sheet is integrated with a buckling sheet and capable of being firmly welded on a substrate through longitudinally adjusting the location of the buckling sheet.

2. Description of Related Art

The package means of memory module mostly are: single in-line memory module (SIMM) or dual in-line memory module (DIMM), wherein the width of data bits of the SIMM is 32 bits while the width of data bits of the DIMM is 64 bits. So one DIMM can process the same amount of data as two SIMMs are capable of, Thus the DIMM is the main stream in the memory module field.

A conventional DIMM electrical connector is often installed with an insulation housing having an insertion slot for receiving a memory module, the insertion slot is installed with a plurality of first conductive terminals and a plurality of second conductive terminals that are aligned with an up/down arrangement means, and two sides of the insulation housing are respectively provided with a resilient arm, a guide slot is installed on each resilient arm for guiding the electrical card being inserted in the insertion slot. But the material of which the insulation housing of said conventional DIMM electrical connector is made is plastic material and the insulation housing is in an elongated shape, so when subject to high temperature environment during manufacturing or transporting, the insulation housing may be deformed and results in that heights of two sides of the insulation housing are different; in such condition, when the electrical connector, the plural first conductive terminals and the plural second conductive terminals are welded on a printed circuit board, false welding may occur due to the height difference, and the electrical connection quality of the electrical connector is lowed.

In view of the disadvantages of conventional electrical connector, the present invention provides an electrical connector for improving said disadvantages.

### SUMMARY OF THE INVENTION

One primary object of the present invention is to provide an electrical connector in which a fastening sheet and a buckling sheet are integrated and capable of being finely adjusted according to the deformed height of an insulation housing for firmly welding the electrical connector on a substrate.

Another object of the present invention is to provide an electrical connector in which at least one reverse stab is installed on a buckling sheet, so when the buckling sheet is connected to an insulation housing, the reverse stab stabs in the insulation housing for preventing the buckling sheet from being separated from the insulation housing and the tensile strength thereof is enhanced.

Still another object of the present invention is to provide an electrical connector capable of reducing components to be punched and electroplated so as to lower the environmental pollution.

For achieving the mentioned objects, the present invention provides an electrical connector, comprises: an insulation housing having an insertion slot for receiving an electrical card, the insertion slot is provided with a plurality of first conductive terminals and a plurality of second conductive terminals that are aligned with an up/down arrangement means, and two sides of the insulation housing are respectively installed with an arm portion, the inner side of each arm portion is provided with a slot hole, the outer side thereof has a latching block; and a buckling sheet having a first sheet member and a second sheet member, the first sheet member is downwardly extended with an extending sheet, right side thereof has a latching hole, the bottom end of the extending sheet is bended so as to form a fastening sheet, and one side of the second sheet member is installed with a wing sheet, when the wing sheet is inserted in the slot hole, the latching block is latched in the latching hole, and a slit is defined at the top or bottom end of the latching block and the latching hole, such that the fastening sheet is able to be firmly welded on a substrate through adjusting the longitudinal location of the latching block inside the latching hole.

### BRIEF DESCRIPTION OF THE DRAWINGS

FIG. 1 is a schematic exploded view of the electrical connector of one preferred embodiment of the present invention;

FIG. 2 is a schematic partially enlarged view of the buckling sheet of one preferred embodiment of the present invention;

FIG. 3 is a schematic front view of the assembly of the electrical connector of one preferred embodiment of the present invention;

FIG. 4 is a schematic view illustrating the electrical connector of one preferred embodiment of the present invention being connected with an electrical card.

### DETAILED DESCRIPTION OF THE PREFERRED EMBODIMENT

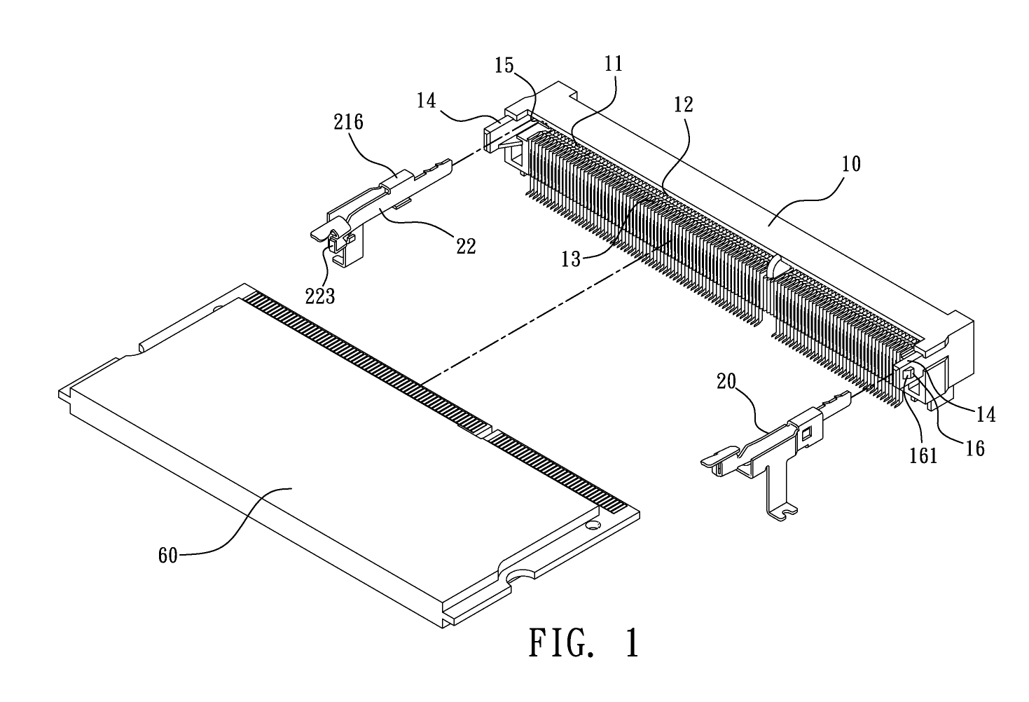

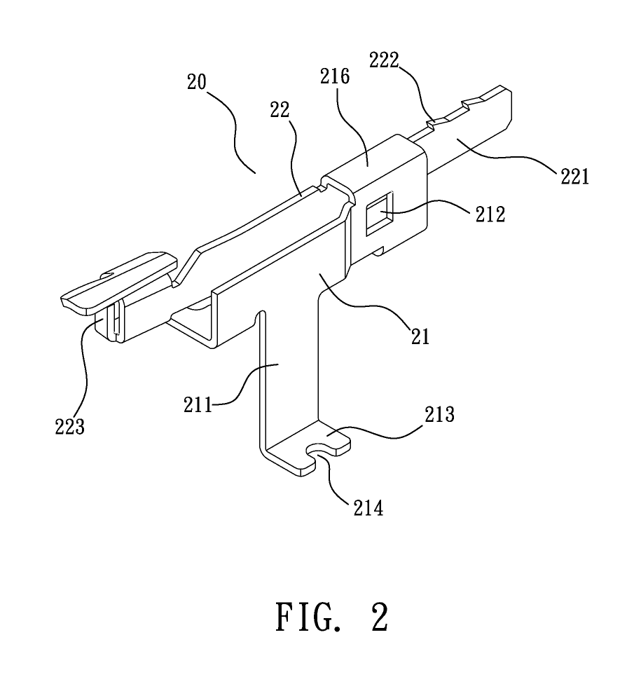

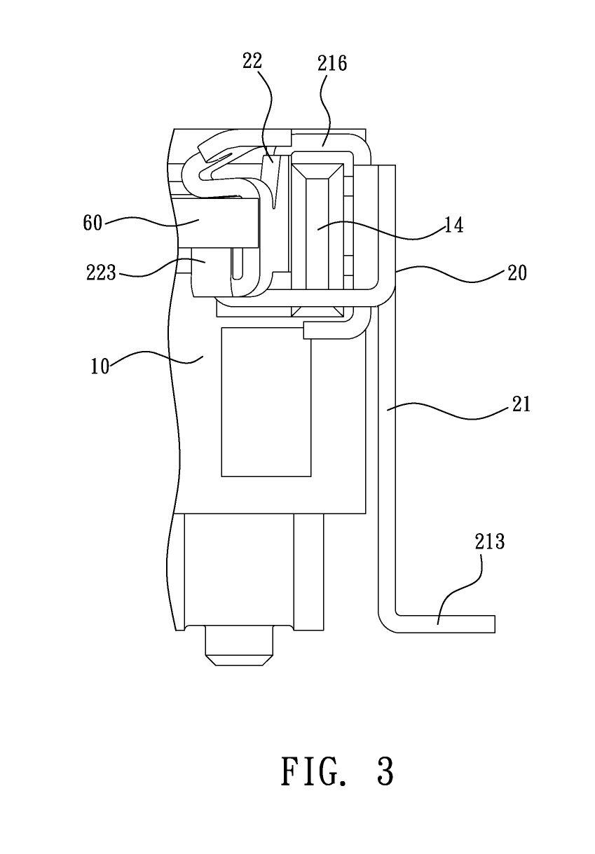

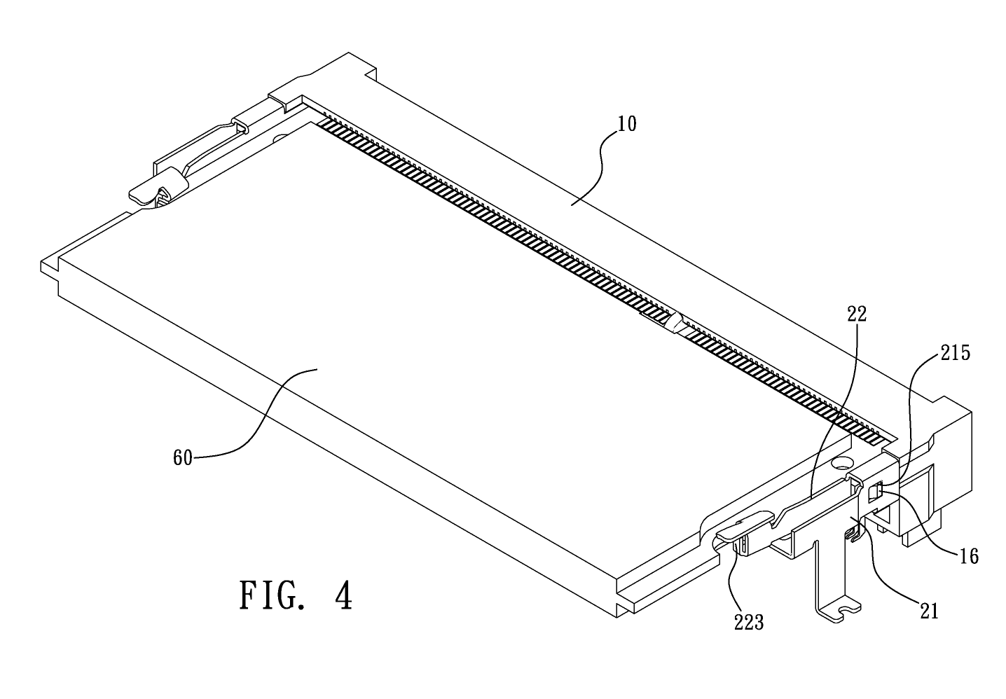

Referring from FIG. 1 to FIG. 4, wherein FIG. 1 is a schematic exploded view of the electrical connector of one preferred embodiment of the present invention; FIG. 2 is a schematic partially enlarged view of the buckling sheet of one preferred embodiment of the present invention; FIG. 3 is a schematic front view of the assembly of the electrical connector of one preferred embodiment of the present invention; and FIG. 4 is a schematic view illustrating the electrical connector of one preferred embodiment of the present invention being connected with an electrical card.

As shown in figures, the electrical connector provided by the present invention comprises: an insulation housing 10; and a buckling sheet 20.

The insulation housing 10 is made of, e.g. but not limited to, plastic material, and is installed with an insertion slot 11 for receiving an electrical card 60, the insertion slot 11 is provided with a plurality of first conductive terminals 12 and a plurality of second conductive terminals 13 that are aligned with an up/down arrangement means, and two sides of the insulation housing 10 are respectively installed with an arm portion 14, the inner side of each of the arm portions 14 has a slot hole 15 for accommodating the electrical card 60, the outer side thereof has a latching block 16. Wherein the electrical card 60 is a, e.g. but not limited to, DIMM card, the plural first conductive terminals 12 and the plural second conductive terminals 13 are conventional arts and well known by skilled people in the arts, so no further illustration is provided.

The buckling sheet 20 is made of metal material, e.g. but not limited to stainless steel, and is installed with a first sheet member 21 and a second sheet member 22, the first sheet member 21 is downwardly extended with an extending sheet 211, the right side thereof has a latching hole 212, the bottom end of the extending sheet 211 is bended so as to form a fastening sheet 213, for example being outwardly bended to 90 degree for forming the fastening sheet 213, and a distal end of the fastening sheet 213 has a fastening hole 214 for being welded on a substrate (not shown), wherein the substrate is a, e.g. but not limited to, computer mother board. One end of the second sheet member 22 has a wing sheet 221, when the wing sheet 221 is inserted in the slot hole 15, the latching block 16 is latched in the latching hole 212, and a slit 215 is defined between the top end or bottom end of the latching block 16 and the latching hole 212, such that the fastening sheet 213 is able to be firmly welded on the substrate through longitudinally adjusting the location of the latching block 16 received in the latching hole 212.

Moreover, a distal end of the first sheet member 21 of the present invention is further installed with a bridging sheet 216 for being connected with the second sheet member 22, and the bridging sheet 216 is disposed on top of the arm portion 14 so as to cover the arm portion 14.

Moreover, the top end of the wing sheet 221 of the present invention is further installed with at least one revere stab 222, in this embodiment two reverse stabs 222 are adopted for illustration but not served as a limitation. When the wing sheet 221 is inserted in the insulation housing 10, the reverse stabs 222 smoothly enter the insulation housing 10; when the buckling sheet 20 is desired to be separated from the insulation housing 10, the reverse stabs 222 enter the insulation housing 10; accordingly, the buckling sheet 20 is prevented from being separated from the insulation housing 10 and the tensile strength thereof is enhanced.

Moreover, the other end, opposite to the end where the wing sheet 221 is installed, of the second sheet member 22 is provided with a position limiting portion 223 capable of being connected with the electrical card 60 for fastening the electrical card 60.

Moreover, one end of the latching block 16, e.g. but not limited to the front end, is formed with an oblique surface 161 for facilitating the connection with the latching hole 212.

As shown in FIG. 3, when being assembled, firstly the wing sheet 221 is inserted into the slot hole 15, so the arm portion 14 is disposed below the bridging sheet 216, the latching block 16 is latched in the latching hole 212; because the slit 215 is defined when the latching block 16 is latched with the latching hole 212, the electrical connector is able to be firmly welded on the substrate through longitudinally adjusting the buckling sheet 20 to a proper location and providing solder in the fastening hole 35 for ensuring the welding stability of the electrical connector. As such, the electrical connector of the present invention is able to be finely adjusted according to the deformed height of the insulation housing 10, so the electrical connector is able to be firmly welded on a substrate.

As shown in FIG. 4, when the electrical card 60 is desired to be inserted in the electrical connector, the electrical card 60 is placed above the position limiting portion 223 and is forwardly moved along the inner sides of the two second sheet members 22 till being inserted and fastened in the insertion slot 11, thus the connection between the electrical connector of the present invention and the electrical card 60 is finished. When the electrical card 60 is desired to be released from the electrical connector, the second sheet member 22 is outwardly pulled so that the electrical card 60 is initially released from the insertion slot 11, then the electrical card 60 is moved along the inner side of the second sheet member 22 for being completely released from the insertion slot 11, the separation between the electrical connector of the present invention and the electrical card 60 is therefore finished.

Accordingly, the electrical connector provided by the present invention is able to be finely adjusted according to the deformed height of the insulation housing for firmly welding the electrical connector on the substrate; the integration of the fastening sheet and the buckling sheet can reduce components to be punched and/or electroplated so as to lower the environmental pollution; and at least one reverse stab is installed on the buckling sheet, when the buckling sheet is connected to the insulation housing, the reverse stab stabs into the insulation housing for preventing the buckling sheet from being separated from the insulation housing and the tensile strength thereof is enhanced. So the electrical connector provided by the present invention is novel compared to conventional electrical connectors.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector, comprising:
an insulation housing having an insertion slot for receiving an electrical card, said insertion slot being provided with a plurality of first conductive terminals and a plurality of second conductive terminals aligned with an up/down arrangement means, and two sides of said insulation housing being respectively installed with an arm portion, the inner side of each arm portion being provided with a slot hole, the outer side thereof having a latching block; and
a buckling sheet having a first sheet member and a second sheet member, said first sheet member being downwardly extended with an extending sheet, right side thereof having a latching hole, the bottom end of said extending sheet being bended so as to form a fastening sheet, and one side of said second sheet member being installed with a wing sheet, when said wing sheet being inserted in said slot hole, said latching block being latched in said latching hole, and a slit being defined at the top or bottom end of said latching block and said latching hole, such that said fastening sheet being firmly welded on a substrate through adjusting the longitudinal location of said latching block inside said latching hole.

2. The electrical connector as claimed in claim 1, wherein said insulation housing is made of plastic material, said buckling sheet is made of metal material, said electrical card is a DIMM card.

3. The electrical connector as claimed in claim 1, wherein a distal end of said first sheet member is further installed with a bridging sheet for being connected with said second sheet member, and said bridging sheet is disposed above said arm portion for covering said arm portion.

4. The electrical connector as claimed in claim 1, wherein said fastening sheet is installed with a fastening hole for being welded on said substrate.

5. The electrical connector as claimed in claim 1, wherein at least one reverse stab is installed on said wing sheet, such that when said wing sheet is inserted in said insulation housing, said reverse stab stabs in said insulation housing for preventing said buckling sheet from being separated from said insulation housing and the tensile strength thereof is enhanced.

6. The electrical connector as claimed in claim 1, wherein the other side of said second sheet member, opposite to the side where said wing sheet is installed, is provided with a position limiting portion for being connected to said electrical card for fastening said electrical card.

7. The electrical connector as claimed in claim 1, wherein one side of said latching block is formed with an oblique surface for facilitating the connection with latching hole.
